(19) United States
(12) Patent Application Publication
(10) Pub. No.: US 2025/0300398 A1
(43) Pub. Date: Sep. 25, 2025

(54) SEPARABLE ELECTRICAL CONNECTOR

(71) Applicant: Eaton Intelligent Power Limited, Dublin (IE)

(72) Inventors: Alexander F. Groth, Milwaukee, WI (US); David Charles Hughes, Aiken, SC (US)

(21) Appl. No.: 19/078,812

(22) Filed: Mar. 13, 2025

Related U.S. Application Data
(60) Provisional application No. 63/567,012, filed on Mar. 19, 2024.

(51) Int. Cl. H01R 13/629; H01R 13/6581; H01R 13/6592; H01R 13/6598; H01R 13/703

(52) U.S. Cl. CPC H01R 13/629; H01R 13/6581; H01R 13/6592; H01R 13/6598; H01R 13/703

(57) ABSTRACT

A separable electrical connector includes: an electrically insulating body including an open end and an interior surface; an electrically conductive shield on the interior surface; an electrically conductive piston inside the electrically insulating body and in contact with the electrically conductive shield; a contact assembly including: an electrically conductive contact connected to the electrically conductive piston; and an electrically insulating contact housing surrounding the electrically conductive contact; and an elastic member surrounding the electrically insulating contact housing.

### CROSS-REFERENCE TO RELATED APPLICATION

This application claims the benefit of U.S. Provisional Application No. 63/567,012, filed on Mar. 19, 2024 and titled SEPARABLE ELECTRICAL CONNECTOR, which is incorporated herein by reference in its entirety.

### TECHNICAL FIELD

This disclosure relates to a separable electrical connector.

### BACKGROUND

An electrical connector is used to connect electrical transmission and distribution equipment and electrical sources within an electrical power distribution system.

### SUMMARY

In one aspect, a separable electrical connector includes: an electrically insulating body including an open end and an interior surface; an electrically conductive shield on the interior surface; an electrically conductive piston inside the electrically insulating body and in contact with the electrically conductive shield; a contact assembly including: an electrically conductive contact connected to the electrically conductive piston; and an electrically insulating contact housing surrounding the electrically conductive contact; and an elastic member surrounding the electrically insulating contact housing.

Implementations may include one or more of the following features.

The elastic member may be configured to compress when the contact assembly and the electrically conductive piston move toward the open end. The separable electrical connector also may include an electrically insulating end piece including an opening that coincides with the open end of the electrically insulating body, and the elastic member may be configured to compress against the electrically insulating end piece when the contact assembly and the electrically conductive piston move toward the open end.

The elastic member may be in an open space between an outer surface of the electrically insulating contact housing and the electrically conductive shield.

The separable electrical connector also may include a second elastic member that surrounds the electrically conductive piston. The second elastic member may be configured to expand when the contact assembly and the electrically conductive piston move toward the open end. The electrically conductive piston may include a piston body and an annular flange that extends radially outward from the piston body, the elastic member may be on a first side of the annular flange, and the second elastic member may be on a second side of the annular flange.

The elastic member may include a spring.

The separable electrical connector also may include: a semiconductive shield on an outer surface of the electrically body; and a cable electrically connected to the electrically conductive shield.

In another aspect, an apparatus for a separable electrical connector includes a contact assembly. The contact assembly includes: an electrically conductive contact including a first end, a second end, and one or more deflectable electrical connection points at the second end, the first end configured for electrical and mechanical attachment to an electrically conductive piston; and an electrically insulating contact housing surrounding the electrically conductive contact, the electrically insulating contact housing extending from a first end to a second end, the first end configured to make contact with the electrically conductive piston. The apparatus also includes an elastic member configured to apply force on the electrically conductive piston.

Implementations may include one or more of the following features.

The elastic member may surround the electrically insulating contact housing.

The elastic member may be a spring.

The contact assembly also may include one or more sealing members and an arc-quenching material.

The apparatus also may include the electrically conductive piston.

In another aspect, a separable electrical connector includes: an insulating body including an open end and an electrically conductive member on an inner surface; a contact assembly in the insulating body, the contact assembly including a contact housing that surrounds an electrical contact; a piston electrically connected to the electrically conductive member; and a spring assembly configured to apply a force on the piston.

Implementations may include one or more of the following features.

The contact assembly may be configured to move between an original position and an outward position, and the spring assembly may be substantially relaxed in the original position.

The spring assembly may be compressed when the contact assembly is in the outward position. The spring assembly may be expanded when the contact assembly is in the outward position.

The contact assembly may be configured to move between an original position and an outward position. The spring assembly may include a first spring and a second spring, the first spring may surround the piston, the second spring may surround the contact housing, the first spring may be expanded when the contact assembly is in the outward position, and the second spring may be compressed with the contact assembly is in the outward position.

In another aspect, a contact assembly for a separable electrical connector includes: an electrically insulating contact housing surrounding an electrically conductive contact, the electrically insulating contact housing including: a sidewall that extends from a first end to a second end, the sidewall including an outer surface, and an inner surface, the inner surface defining an open interior, the inner surface including a recess that faces the open interior. The contact assembly also includes an electrically conductive contact in the open interior, the electrically conductive contact including: a first end, a second end, and one or more deflectable electrical connection points at the second end. The first end is configured for electrical and mechanical attachment to an electrically conductive piston in the separable electrical connector.

The recess may be a channel that surrounds the open interior.

Implementations of any of the techniques described herein may include a system, an apparatus, a separable electrical connector, a device, and/or a method. The details of one or more implementations are set forth in the accompanying drawings and the description below. Other features will be apparent from the description and drawings, and from the claims.

### DRAWING DESCRIPTION

FIGS. 1A and 1B are block diagrams of an alternating current (AC) electrical power distribution system that includes a separable electrical connector.

FIG. 2 is a side cross-sectional view of another electrical connector with a contact assembly in an original position.

FIG. 3 is a cross-sectional view of the electrical connector of FIG. 2 taken along the line 3-3′ of FIG. 2.

FIG. 4 is a side cross-sectional view of the contact assembly of the electrical connector of FIG. 2.

FIG. 5 is a side cross-sectional view of a piston of the electrical connector of FIG. 2.

FIG. 6 is a perspective exterior view of a contact housing of the contact assembly.

FIG. 7 is a side cross-sectional view of the electrical connector of FIG. 2 with the contact assembly in an outward position.

FIG. 8A is a perspective exterior view of another contact housing.

FIG. 8B is a side cross-sectional view of the contact housing of FIG. 8A.

FIG. 8C is an end view of the contact housing of FIG. 8A as seen from the line 8C-8C′ of FIG. 8B.

FIG. 9 is a side cross-sectional view of another contact assembly.

FIG. 10 is a side cross-sectional view of an electrical connector that includes the contact assembly of FIG. 9.

FIG. 11 is a partial side cross-sectional view of another electrical connector.

FIG. 12 is a side cross-sectional view of a piston.

FIG. 13 is a side cross-sectional view of part of an electrical connector.

### DETAILED DESCRIPTION

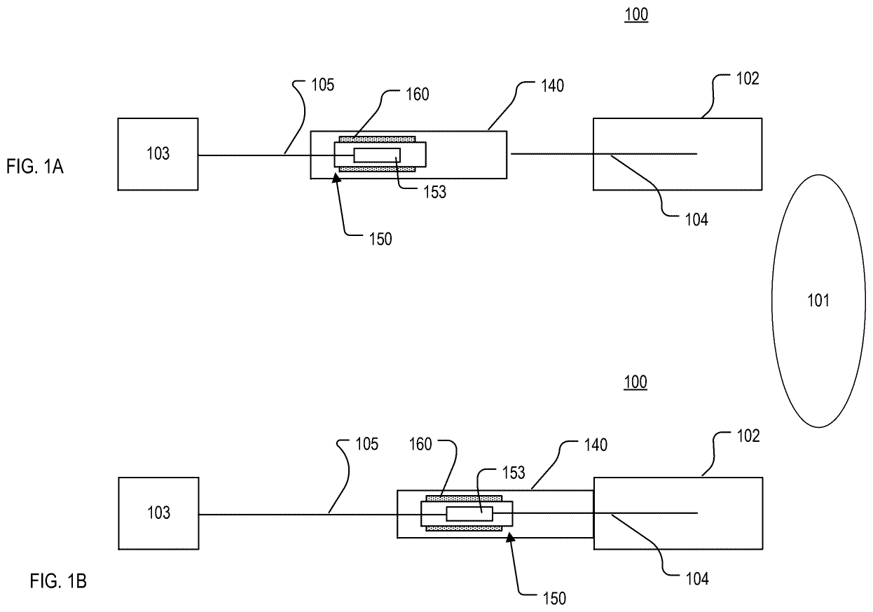

FIGS. 1A and 1B are block diagrams of an alternating current (AC) electrical power distribution system 100 that includes an electrical device 102 and a separable electrical connector 140. The separable electrical connector 140 can be moved and manipulated by a human operator and/or with a hotstick. The electrical connector 140 may be, for example, a bushing insert, a loadbreak elbow connector, deadbreak elbow connector, a loadbreak T-body, or a deadbreak T-body T-connector.

The electrical connector 140 also includes a cable or wire 105 that is electrically connected to an electrical contact 153 inside the electrical connector 140. The cable 105 is also connected to an electrical node 103. The electrical node 103 may be, for example, a conductor in another electrical device or a grounding point. The electrical device 102 is any type of electrical device that includes a conductive probe 104. For example, the electrical device 102 may be a cable connector or an electrical device (such as a transformer, capacitor bank, or voltage regulator) that includes a conductor that extends through a bushing. The electrical connector 140 is configured to be connected to and disconnected from the electrically conductive probe 104. When the contact assembly 150 and the probe 104 are electrically connected, current can flow between the electrical device 102 and the node 103. When the contact assembly 150 and the probe 104 are not electrically connected, current cannot flow between the electrical device 102 and the node 103.

The electrical connector 140 also includes an elastic member 160. The elastic member 160 may be, for example, a spring. As discussed below, the elastic member 160 improves the overall performance of the electrical connector 140. For example, the clastic member 160 decreases the amount of time to perform load make and load break operations and reduces arcing. The elastic member 160 also returns the contact assembly to its original steady-state operation position after a fault closure condition, thereby improving the overall safety and usability of the electrical connector 140.

An overview of the AC electrical power distribution system 100 is provided before discussing various examples of the electrical connector 140.

The electrical connector 140 may have any shape. For example, the electrical connector 140 may be substantially linear in shape, U-shaped, T-shaped, C-shaped, or L-shaped. The electrical connector 140 may be rated for loadbreak and loadmake operations at, for example, 200 Amperes (A), 600 A, 900 A, or 1200 A and may have a rated voltage of up to 15 kilovolts (kV), up to 25 kV, or up to 35 kV. In some implementations, the electrical connector 140 is rated for operation at 35 kilovolts (kV) and 600 A. These current and voltage values are provided as examples, and the electrical connector 140 may have a different rated current and/or voltage.

The device 102 is any type of device or system that utilizes electricity and that has a bushing configured for connection to the electrical connector 140. The device 102 may be, for example, a voltage regulator, a transformer, a switching apparatus, a junction, or a sectionalizing cabinet. The AC electrical power distribution system 100 includes an AC power grid 101. The power grid 101 is a three-phase power grid that operates at a fundamental frequency of, for example, 50 or 60 Hertz (Hz). The power grid 101 includes devices, systems, and components that transfer, distribute, generate, use, and/or absorb electricity. For example, the power grid 101 may include, without limitation, generators, power plants, electrical substations, transformers, renewable energy sources, distributed energy sources (DERs), transmission lines, reclosers and switchgear, fuses, surge arresters, combinations of such devices, and any other device used to transfer or distribute electricity. A DER is an electricity-producing resource and/or a controllable load. Examples of DER include, for example, solar-based energy sources such as, for example, solar panels and solar arrays; wind-based energy sources, such as, for example, wind turbines and windmills; combined heat and power plants; rechargeable sources (such as batteries); natural gas-fueled generators; electric vehicles; and controllable loads, such as, for example, some heating, ventilation, air conditioning (HVAC) systems and electric water heaters.

The power grid 101 may be low-voltage (for example, up to 5 kilovolts (kV)), medium-voltage or distribution voltage (for example, between 5 kV and 46 kV), or high-voltage (for example, 46 kV and greater). The power grid 101 may include more than one sub-grid or portion. For example, the power grid 101 may include AC micro-grids, AC area networks, or AC spot networks that serve particular customers. These sub-grids may be connected to each other via switches and/or other devices to form the grid 101. Moreover, sub-grids within the grid 101 may have different nominal voltages. For example, the grid 101 may include a medium-voltage portion connected to a low-voltage portion through a distribution transformer. All or part of the power grid 101 may be underground.

The electrical power distribution system 100 may include additional components and systems that are not shown or discussed above. For example, the electrical power distribution system 100 may include cabinets, transformers, transmission lines and cables, substations, and support structures, just to name a few. All or part of the electrical power distribution system 100 may be underground. Moreover, the device 102 may be underground, and the electrical connector 140 may be used underground or above ground.

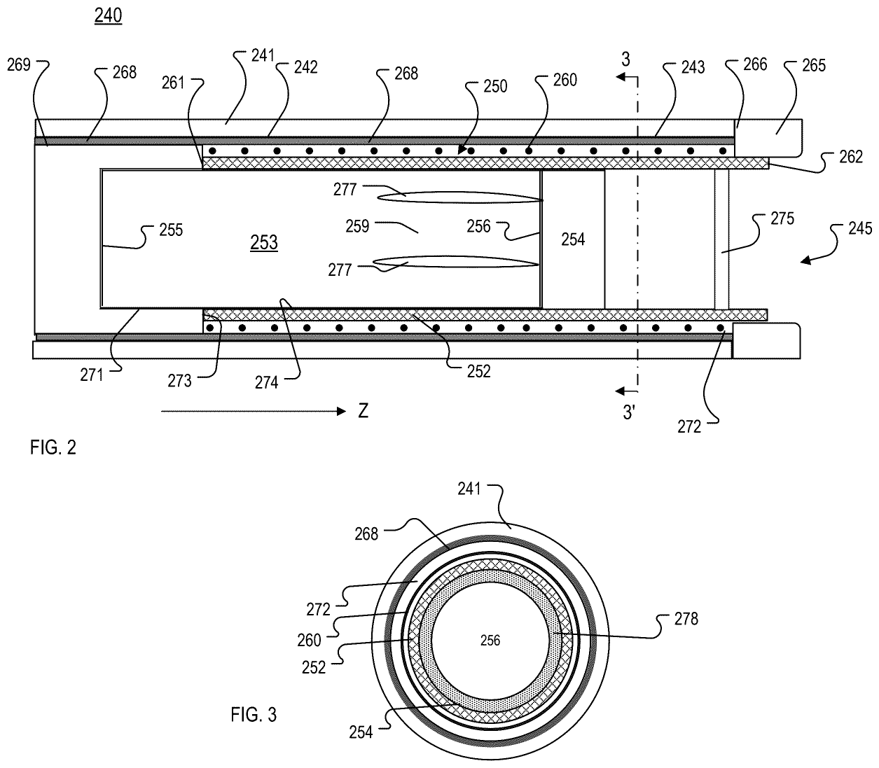

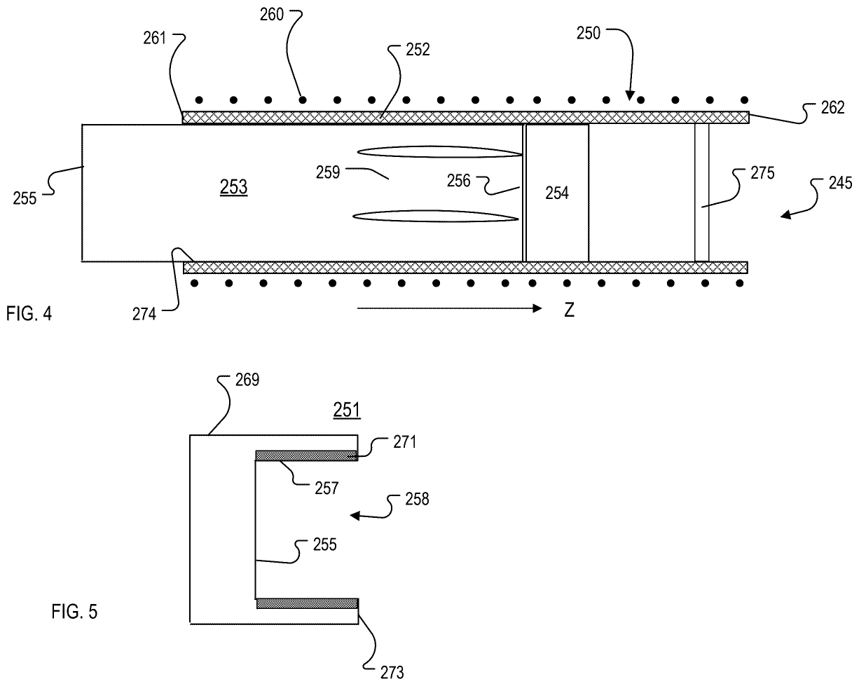

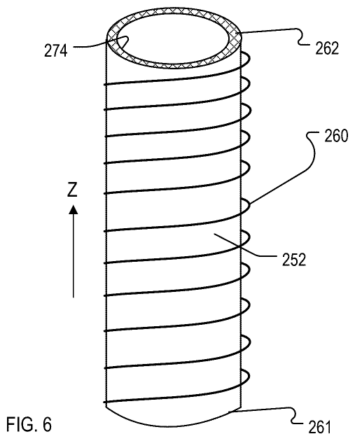

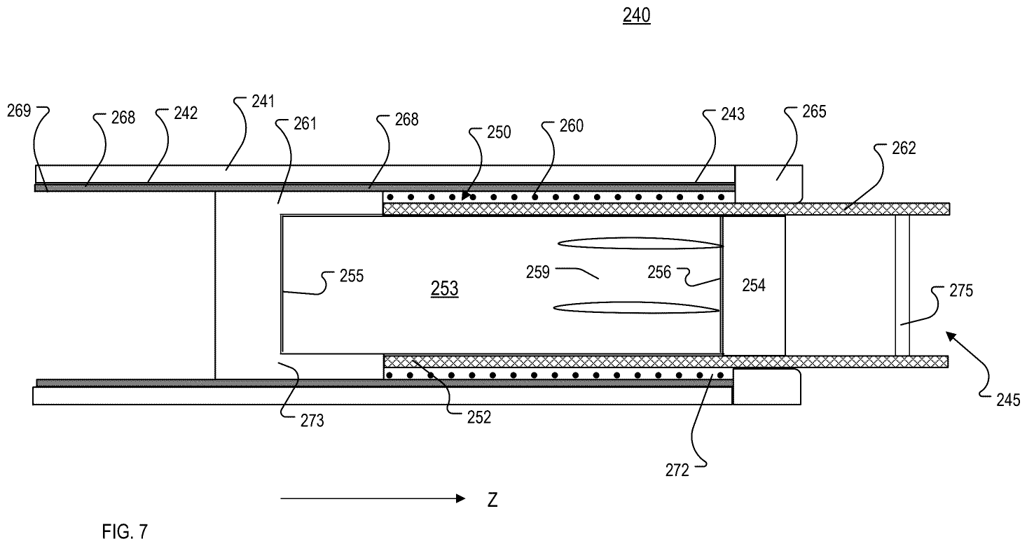

FIGS. 2-7 relate to an electrical connector 240. The electrical connector 240 is a separable electrical connector and may be used to connect the probe 104 (FIGS. 1A and 1B) to the node 103. The electrical connector 240 includes a contact assembly 250 that is mechanically biased by a spring 260. FIG. 2 is a side cross-sectional view of the electrical connector 240 with the contact assembly 250 in an original position. The electrical connector 240 is in the original position under normal, steady-state operating conditions. FIG. 3 is a cross-sectional view of the electrical connector 240 taken along the line 3-3′ of FIG. 2. FIG. 4 is a side cross-sectional view of the contact assembly 250 and the spring 260. FIG. 5 is a side cross-sectional view of a piston 251 of the electrical connector 240. FIG. 6 is a perspective exterior view of a contact housing 252 of the contact assembly 250 and the spring 260. FIG. 7 is a side cross-sectional view of the electrical connector 240 with the contact assembly 250 in an outward position.

Referring to FIG. 2, the electrical connector 240 includes a body 241. The body 241 is made of an electrically insulating material such as, for example, ethylene-propylene-dienemonomoer (EPDM), a polymer, or a rubber material. The body 241 includes an inner surface 242 that defines a bore 243 that is open at an end 245. The contact assembly 250 is in the bore 243. The contact assembly 250 includes an electrically conductive contact 253, an arc interrupter 254, and a contact housing 252 (shown in cross-hatch shading).

The electrically conductive contact 253 extends generally in the Z direction from a first end 255 to a second end 256. The first end 255 of the contact 253 is in a recess 258 (FIG. 5) of the piston 251. The first end 255 of the contact 253 is attached to the piston 251 at an interface 271 (FIG. 5). The interface 271 may be, for example, a threaded interface in which external threads on the first end 255 of the contact 253 are attached to corresponding threads on an inner sidewall 257 of the recess 258 of the piston 251. The contact 253 and the piston 251 are made of electrically conductive materials such that attaching the first end 255 to the piston 251 at the interface 271 also electrically connects the contact 253 and the piston 251. The piston 251 and the electrical contact 253 may be made of a metal such as, for example, copper.

The second end 256 of the contact 253 includes deflectable electrical connection points 259 that are separated by openings or slots 277 in the contact 253. The one or more electrical connection points 259 may be, for example, deflectable finger contacts. The arc interrupter 254 is adjacent to the end 256. The arc interrupter 254 includes an ablative material. In the electrical connector 240, the arc interrupter 254 is a ring that is filled with an ablative material 278 (shown with dotted shading in FIG. 3). Other implementations are possible.

The contact housing 252 extends from a first end 261 to a second end 262 along the Z direction. The contact housing 252 surrounds the contact 253 and the arc interrupter 254. The contact housing 252 may be tube that is lined or filled with an ablative material. In some implementations, the contact housing 252 is an epoxy resin, thermoset, or fiberglass tube that surrounds an ablative material. The first end 261 of the contact housing 252 abuts a top end 273 of the piston 251, and the second end 262 extends toward the open end 245 of the bore 243. The first end 261 of the contact housing 252 may be internally roughened or threaded to encourage bonding between an interior wall 274 of the contact housing 252 and the contact 253.

The second end 262 of the contact housing 252 includes features (for example, threads) on an inner wall that engage with one or more sealing members 275 (one sealing member 275 is shown in FIG. 2). The one or more sealing members 275 may be, for example O-rings or rubber gaskets. The sealing member 275 seals against a probe (such as the probe 104) of an external device. The arc interrupter 254 is between the one or more sealing members 275 and the second end 256 of the contact 253, with the sealing members 275 being relatively near the open end 245 of the bore 243.

The electrical connector 240 also includes an insulating end piece 265 (FIG. 2) that is attached to an end of the body 241. The insulating end piece 265 surrounds the open end 245 of the bore 243 and a portion of the contact housing 252. The insulating end piece 265 forms an annular shoulder 266. The insulating end piece 265 may be made of any durable, electrically insulating material. For example, the end piece 265 may be made of EDPM rubber.

The electrical connector 240 also includes an electrically conductive shield 268 that surrounds the piston 251 and the contact housing 252. The electrically conductive shield 268 may be a tube that is in the bore 243 and in contact with the inner surface 242 of the body 241. In some implementations, the electrically conductive shield 268 is a metallic coating on the inner surface 242 of the body 241.

The electrically conductive shield 268 is electrically connected to an output cable (such as the cable 105 shown in FIGS. 1A and 1B). The electrically conductive shield 268 is also in contact with an outer surface 269 of the piston 251. Thus the electrically conductive shield 268 is electrically connected to the piston 251 and to the output cable. However, the shield 268 is radially separated from the contact housing 252, and there is an open region 272 between the contact housing 252 and the shield 268. The electrically conductive shield 268 is not in direct contact with the contact housing 252.

The spring 260 surrounds the contact housing 252. The spring 260 may be any type of spring. For example, the spring 260 may be a helical spring, a spiral spring, or a compression spring. The spring 260 may be made of a tin-plated music wire steel or any other material that is able to maintain functionality and shape over a wide range of forces (for example, 50 to 1000 pound force (lbf) or about 222 to 4900 Newtons) and is resistant to arcing-based corrosion. Other examples of materials that may be used for the spring 260 include, without limitation, stainless steel and chrome steel.

As shown in FIGS. 2 and 3, the spring 260 is in the open region 272. One end of the spring 260 is attached to the shoulder 266 and the other end is attached to the top 273 of the piston 251. The spring 260 may be floating in the open region 272 with one end of the spring 260 resting on the shoulder 266 and the other end resting on the top 273 of the piston. The ends of the spring 260 remain connected to the shoulder 266 and the top 273, and the spring 260 expands and contracts in the open region 272 as the piston 251 and the contact assembly 250 move axially relative to the shoulder 266.

The spring 260 has an expanded state, a compressed state, and an equilibrium or relaxed state. When the spring 260 is not in the equilibrium state, the spring 260 applies a spring force in the direction that would bring the spring 260 to the equilibrium state. In the electrical connector 240, when the spring 260 is in the expanded state, the spring 260 has a relatively greater axial extent and applies a spring force on the piston top 273 in a direction that would compress the spring. When the spring 260 is in the compressed state, the spring 260 has a relatively smaller axial extent and applies the spring force on the piston top 273 in the direction that would expand the spring.

Under typical, steady state operating conditions, the electrical connector 240 is connected to an external device, such as the electrical device 102 (FIGS. 1A and 1B) and the spring 260 is substantially in its equilibrium or relaxed state. Under steady state operating conditions, the spring 260 is relaxed or substantially relaxed (in a slightly compressed state that is nearly the relaxed state). Having the spring 260 in a slightly compressed state during steady state operating conditions helps to keep the spring 260 in place in the open region 272 in implementations in which the spring 260 is floating in the open region 272.

The conductive probe 104 extends through the open end 245 and is in physical and electrical contact with the electrical connection points 259 at the end 256 of the contact 253. Electrical current can flow into the electrically conductive shield 268, through the piston 251 and contact 253, and into the conductive probe (not shown in FIG. 2) of the external device. Electrical current does not flow in the spring 260 and the spring 260 is not part of the intentional current path through the electrical connector 240. The piston 251 and the contact assembly 250 do not move axially relative to the bore 243 and the electrically conductive shield 268 under typical steady state load conditions.

A fault closure condition occurs when the contact 253 and the probe are joined when one of the conductors is energized and the other conductor is engaged with a load having a fault, such as a short circuit condition. In fault closure conditions, substantial arcing may occur between the contact 253 and the probe as they approach one another and until they are in direct physical contact. During a fault closure condition, the piston 251 and the contact assembly 250 move axially relative to the electrically conductive shield 268 and the bore 243 from the position shown in FIG. 2 (the original position) toward the open end 245 to the position shown in FIG. 7 (the outward position). Without the spring 260, the contact assembly 250 would remain in the outward position after the connection points 259 and the probe make contact. On the other hand, the electrical connector 240 includes the spring 260. When the contact assembly 250 moves from the original position toward the open end 245, the spring 260 compresses against the shoulder 266. Thus, when the contact assembly 250 is in the outward position, the spring 260 seeks to return to its equilibrium state and applies a force on the piston 251 in the-Z direction. The force brings the contact assembly 250 and the piston 251 back to the original position, thus avoiding the need for a human operator to manipulate the electrical connector 240 to return the contact assembly 250 and the piston 251 to the original position. In this way, the spring 260 enhances the efficiency of the electrical connector 240 and encourages safe operation.

Additionally, the spring 260 improves the performance of the electrical connector 240 during a loadmake operation. During a loadmake operation, a probe (such as the probe 104) is inserted through the open end 245 and into the contact housing 252 toward the connection points 259. Arcing begins as the probe approaches the electrical connection points 259. The arcing produces gases that escape the electrical connector 240 through the open end 245. Without the spring 260, the pressure and flow direction of the gasses tend to oppose the motion of the probe, thereby increasing the amount of time needed to make the electrical connection between the probe and the electrical connection points 259.

On the other hand, with the spring 260, the gasses created by the arcing move the contact assembly 250 in the Z direction, bringing the connection points 259 closer to the probe, reducing the amount of time to make the electrical connection between the probe and the connection points 259 and also compressing the spring 260. The arcing ends when the electrical connection is made. After the electrical connection is made, the force generated by the compressed spring 260 returns the contact assembly to the original position (FIG. 2) while also helping to maintain the electrical connection between the probe and the connection points 259.

Furthermore, the spring 260 improves the performance of the electrical connector 240 during a loadbreak operation. During a loadbreak operation, the connection points 259 apply a radial (or hoop) force on the probe due to the interference fit between the probe and the connection points 259. As the probe is removed from the electrical connector 240, the contact assembly 250 moves with the probe in the Z direction and the spring 260 compresses against the shoulder 266 until the frictional force of the interference fit is overcome by the force of the compressing spring 260. When the force of the compressing or compressed spring 260 is greater than the bonding force of the interference fit, the force from the spring 260 propels the contact assembly 250 in the-Z direction back to the original position (FIG. 2) while the probe separates from the connection points 259 and continues to move in the Z direction and out of the electrical connector 240. The action of the spring 260 causes the probe to separate from the connection points 259 faster than in an electrical connector that lacks the spring 260. This reduces the amount of time and distance required to separate the probe from the connection points 259 and thereby also reduces arcing during the loadbreak operation.

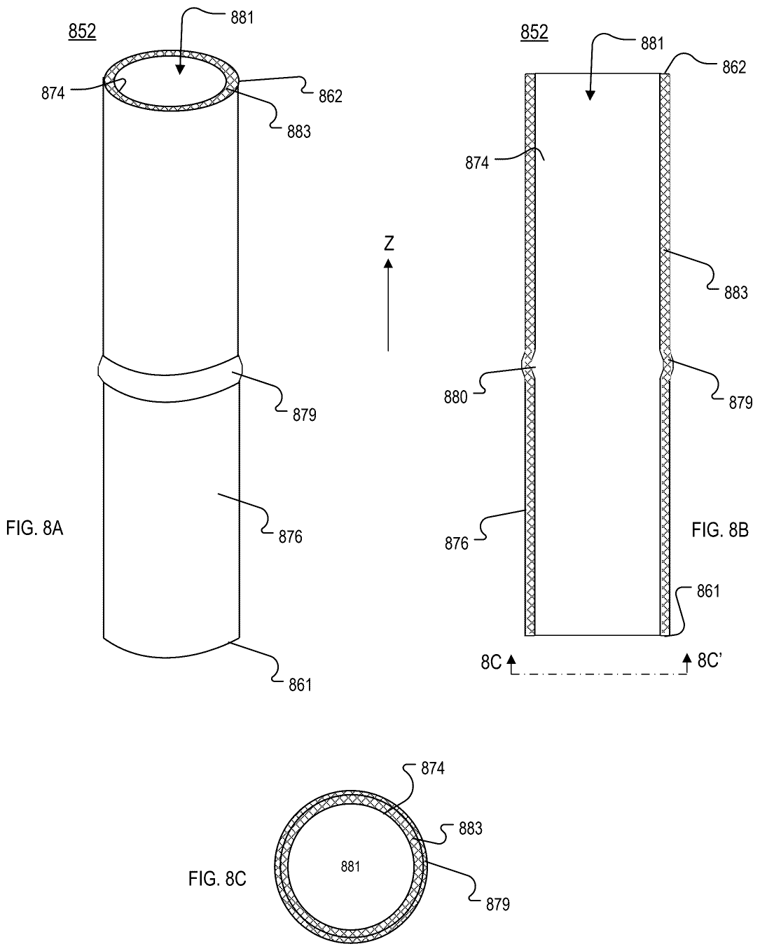

FIG. 8A is a perspective exterior view of another contact housing 852. FIG. 8B is a side cross-sectional view of the contact housing 852. FIG. 8C is an end view of the contact housing 852 as seen from the line 8C-8C′ of FIG. 8B. The contact housing 852 is similar to the contact housing 252 except the contact housing 852 includes a channel 880.

The contact housing 852 is generally a cylindrical or tubular structure with a sidewall 883 that extends along the Z direction from a first end 861 to a second end 862. The contact housing 852 is an electrically insulating material that is rigid or semi-rigid. For example, the contact housing 852 may be made of epoxy, a thermoset, ceramic, fiberglass, or a polymer material. The contact housing 852 includes an exterior surface 876 and an interior wall 874 that defines an open interior 881. The interior wall 874 may be lined or coated with an ablative and/or arc-quenching material.

The contact housing 852 also includes a channel 880 in the interior wall 874. The channel 880 surrounds the interior space 881. In the example shown, the channel 880 is an inner part of an annular protrusion region 879. The annular protrusion region is part of the sidewall 883. The annular protrusion region 879 has a larger diameter than the other parts of the sidewall 833. In the example, shown in FIGS. 8A-8C, the thickness of the sidewall 883 is substantially the same from the first end 861 to the second end 862.

Other implementations of the contact housing are possible. For example, the contact housing 852 may lack the annular protrusion region 879. In these implementations, the channel 880 is an indentation or recess in the interior wall 874 but the exterior surface 876 of the sidewall 883 is smooth from the first end 861 to the second end 862. In other words, in these implementations, the channel 880 corresponds to a portion of the sidewall 883 that has a thinner radial thickness than the other portions of the sidewall 883.

In another example, the channel 880 does not necessarily surround the interior space 881. For example, the channel 880 may be a plurality of discrete recesses formed in the interior wall 874.

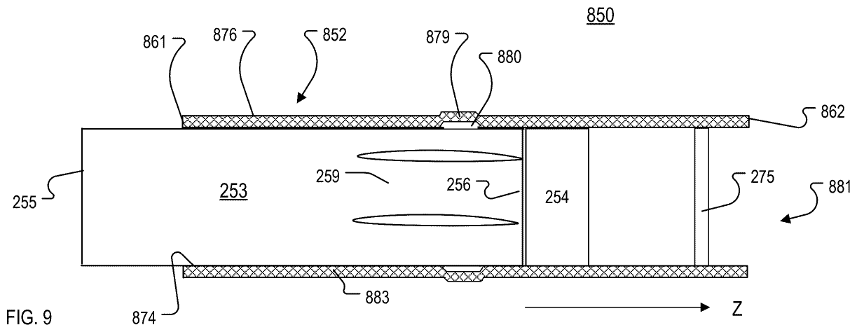

FIG. 9 is a side cross-sectional view of a contact assembly 850. The contact assembly 850 is the same as the contact assembly 250, except the contact assembly 850 includes the contact housing 852 instead of the contact housing 252. As shown in, for example, FIG. 4, in the contact assembly 250, the portions of the interior wall 274 that surrounds the contact 253 are in direct contact with at least a portion of the outer surface of the contact 253. In the contact assembly 850, the portions of the interior wall 874 that surround the contact 253 are in direct contact with the contact 253 except for the portions of the interior wall 874 that are part of the protrusion region 879. As shown in FIG. 9, the protrusion region 879 is separated from the contact 253 such that the channel 880 is a region of open space between the contact 253 and the interior wall 874.

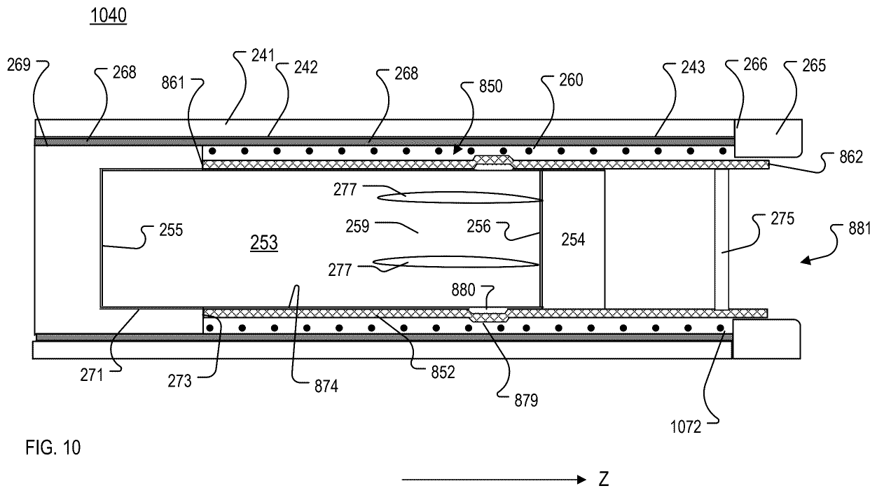

FIG. 10 is a side cross-sectional view of an electrical connector 1040 that includes the contact assembly 850. The electrical connector 1040 is the same as the electrical connector 240 except the electrical connector 240 includes the contact assembly 850 instead of the contact assembly 250. In the electrical connector 1040, the protrusion region 879 extends radially into an open region 1072 that is between the contact housing 852 and the electrically conductive shield 268. The spring 260 is in the open region 1072. The channel 880 is an open region between the connection points 259 on the contact 253 and the interior wall 874 of the contact housing 852.

The channel 880 may improve the overall performance of the electrical connector 1040. For example, during a loadmake or loadbreak operation, arcing may occur as the connection points 559 and an electrically conductive probe approach each other or separate from each other. The channel 880 provides an open volume in the vicinity of the connection points 259. Gasses generated during arcing flow into the channel 880 and are dispersed throughout a larger volume, and the pressure exerted by the gasses is reduced. In this way, the channel 880 reduces the force that the gasses exert and helps to reduce or eliminate a separating force between the connection points 259 and the probe. By reducing or eliminating the separating force, the channel 880 prevents or reduces blowback and increases the switching speed of the electrical connector 1040.

Although the contact assembly 850 is shown in the electrical connector 1040, which includes the spring 260, the contact assembly 850 may be used in other electrical connectors and may be used in an electrical connector that lacks the spring 260.

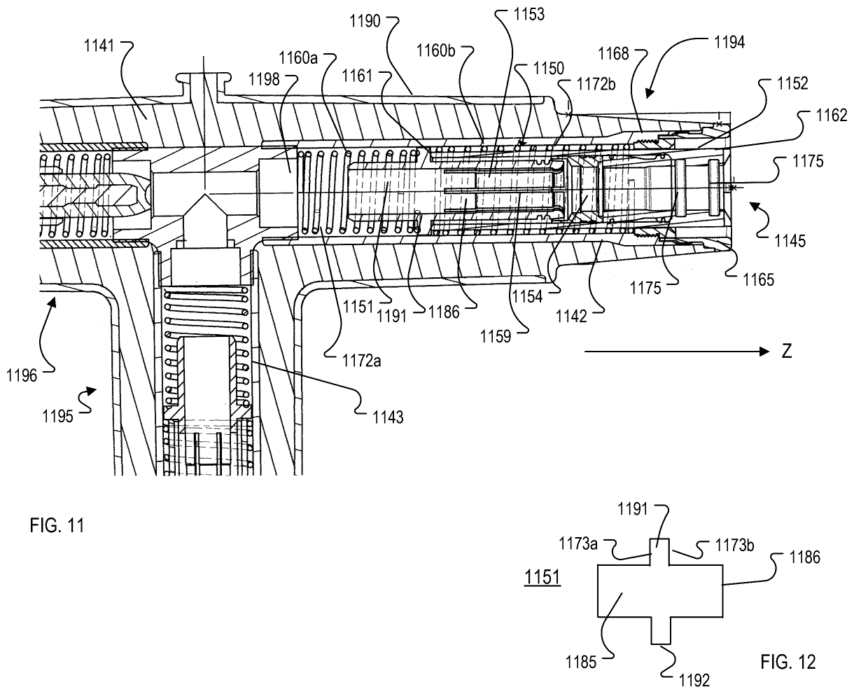

FIG. 11 is a partial side cross-sectional view of another electrical connector 1140. The electrical connector 1140 is a T-body electrical connector that includes an electrically insulating housing or body 1141 and a semiconductive shield 1190 on an exterior of the body 1141. The body 1141 includes an interior surface 1142 that defines a T-shaped bore 1143. The bore 1143 includes first and second portions 1194, 1196 that extend along the Z direction and a third portion 1195 that extends perpendicularly from the first and second portions 1194, 1196. The first portion 1194 is a separable electrical connector that includes a spring-loaded contact assembly 1150. The first portion 1194 has an open end 1145. The second and third portions 1196 and 1195 may be configured in any manner. The third portion 1195 may include, for example, a metal oxide varistor (MOV) arrester. Only the first portion 1194 is discussed in detail.

The electrical connector 1140 includes a contact assembly 1150 that is in the first portion 1194. The contact assembly 1150 includes an electrically conductive contact 1153, an arc interrupter 1154, sealing members 1175, and a contact housing 1152. The contact housing 1152 is a tubular or cylindrical structure that extends from an end 1161 to an end 1162. The contact housing 1152 surrounds the contact 1153, the arc interrupter 1154, and part of an electrically conductive piston 1151. The electrically conductive contact 1153 includes connection points 1159. The connection points 1159 are electrically conductive and may be, for example, deflectable metal finger contacts.

The piston 1151 is also in the first portion 1194. Referring also to FIG. 12, which is a side cross-sectional view of the piston 1151, the piston 1151 includes a piston body 1185 and an annular flange 1191 that extends radially outward from the piston body 1185. The piston body 1185 is cylindrical, with an end 1186 of the piston body 1185 in contact with or receiving the contact 1153 such that the contact 1153 and the piston 1151 are electrically connected to each other.

The electrical connector 1140 also includes an electrically conductive shield 1168 on the interior surface 1142 of the housing 1141. The electrically conductive shield 1168 may be, for example, a metal tube or a metal coating. The electrically conductive shield 1168 surrounds the piston 1151 and the contact housing 1152. The electrically conductive shield 1168 is in direct contact with an outer surface 1192 of the annular flange 1191, but the electrically conductive shield 1168 is radially separated from and is not in direct contact with the body 1185 of the piston 1151 and the contact housing 1152. There is a first open region 1172a between the body 1185 of the piston 1151 and the electrically conductive shield 1168, and a second open region 1172b between the contact housing 1152 and the electrically conductive shield 1168. The annular flange 1191 is between the open regions 1172a and 1172b.

The electrical connector 1140 also includes a first spring 1160a and a second spring 1160b. The first spring 1160a surrounds the body 1185 of the piston 1151 and is in the first open region 1172a. The first spring 1160a is attached to a wall element 1198 and to a first side 1173a of the annular flange 1191. The second spring 1160b is attached to a second side 1173b of the annular flange 1191 and to a shoulder 1166 of an insulating end piece 1165. The insulating end piece 1165 is attached to one end of the body 1141 and surrounds the open end 1145.

Under ordinary, steady-state operation conditions of the electrical connector 1140, a conductive probe of a separate device is in the bore 1143 and the contact housing 1152, and the probe is electrically connected to the connection points 1159. The first spring 1160a and the second spring 1160b are in the relaxed or equilibrium state or in a slightly compressed state.

During a load make operation, the probe is inserted into the open end 1145 and into the contact housing 1152 toward the connection points 1159. Arcing begins, and gasses generated by the arcing move the contact assembly 1150 and the piston 1151 in the Z direction toward the open end 1145 such that the probe and the connection points 1159 make electrical contact. Additionally, the movement of the contact assembly 1150 and the piston 1151 in the Z direction causes the second spring 1160b to compress against the annular shoulder 1166 and the first spring 1160a to expand. Because each spring 1160a, 1160b applies a force in the direction of its equilibrium state, each of the first and second spring 1160a and 1160b exerts a force in the-Z direction on the annular flange 1191. The forces of the springs 1160a and 1160b return the piston 1151 and the contact assembly 1150 to the original position (shown in FIG. 11). This reduces arcing and reduces the overall amount of time for the load make operation.

During a load break operation, the probe is removed from the connection points 1159. At the beginning of the load break operation, the probe is moved in the Z direction. Due to a hoop or radial force between the connection points 1159 and the probe, the connection points 1159 and the probe remain connected to the connection points 1159 as the piston 1151 and contact assembly 1150 move axially in the Z direction toward the open end 1145. Additionally, as the contact assembly 1150 and the piston 1151 move in the Z direction, the first spring 1160a expands and the second spring 1160b contracts. Thus, both springs 1160a, 1160b apply force in the-Z direction to the piston 1151. When the force applied by the springs 1160a, 1160b exceeds the frictional force between the probe and the connection points 1159, the probe separates from the connection points 1159 and the force of the springs 1160a, 1160b propels the piston 1151 and the contact assembly 1150 back to the original position while the probe exits the open end 1145. This reduces arcing and reduces the overall time of the load break operation as compared to an electrical connector that lacks a spring-loaded contact assembly.

Other implementations are possible. For example, in some implementations, the electrical connector 1140 includes the spring 1160a but does not include the spring 1160b.

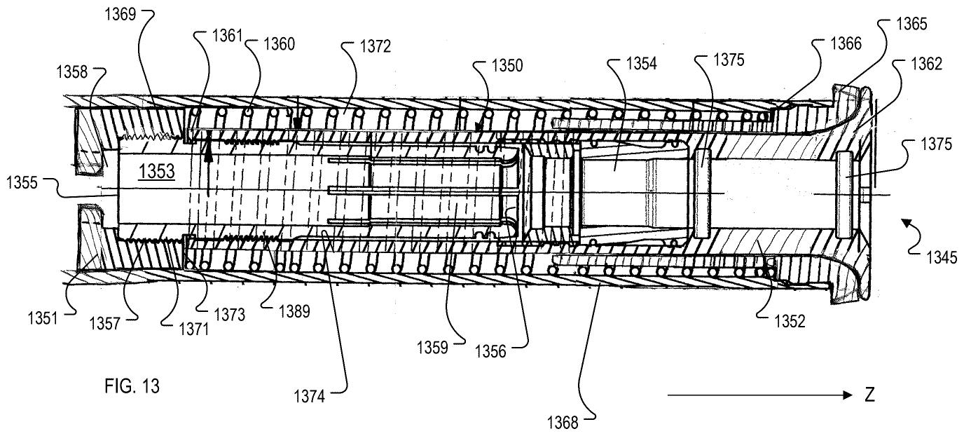

FIG. 13 is a side cross-sectional view of part of an electrical connector 1340. The electrical connector 1340 includes components, such as an insulating body and a semiconductive shield on the insulating body which are not shown in FIG. 13. The electrical connector 1340 may be a load break bushing rated for 600A.

The electrical connector 1340 includes an electrically conductive shield 1368 that surrounds a piston 1351, at least a portion of a contact assembly 1350, and a spring 1360. The contact assembly 1350 includes an electrically conductive contact 1353, an arc extinguisher 1354, sealing members 1375, and a contact housing 1352. The electrically conductive contact 1353 extends along the Z direction from a first end 1355 to a second end 1356. The contact 1353 includes connection points 1359 near the second end 1356.

The piston 1351 is an electrically conductive element that is generally cylindrical and defines a recess 1358. The recess 1358 is partially defined by threaded inner walls 1357. The piston 1351 is connected to the first end 1355 of the electrical contact 1353 at the threaded inner wall 1357. Specifically, threads on an outer surface of the contact 1353 near the end 1355 are threaded into the threads on the threaded inner wall 1357 to seat the contact 1353 in the recess 1358 and attach the contact 1353 to the piston 1351 at a threaded interface 1371. The contact 1353 and the piston 1351 are made of an electrically conductive material (such as copper). Thus, connecting the contact 1353 and the piston 1351 at the threaded interface 1371 also electrically connects the contact 1353 and the piston 1351.

The contact housing 1352 extends along the Z direction from a first end 1361 to a second end 1362. The first end 1361 abuts a piston flange 1373, and the second end 1362 opens to the open end 1345. The contact housing 1352 is a hollow structure with an interior surface 1374. The contact housing 1352 is generally cylindrical but includes a flared open end portion at the second end 1362. The contact housing 1352 is made of an electrically insulating material such as, for example, fiberglass, thermoset, or a polymer.

The contact housing 1352 surrounds the contact 1353 and the arc-extinguisher 1354. The interior surface 1374 of the contact housing 1352 is in direct contact with an exterior of the contact 1353. The contact housing 1352 includes interior threads 1389 that mate with corresponding exterior threads on the contact 1353 to secure the contact 1353 in the contact housing 1352. The contact housing 1352 includes additional interior threads or other features in the interior surface 1374 that hold scaling members 1375. The sealing members 1375 may be, for example, rubber gaskets or O-rings.

The electrical connector 1340 also includes an electrically insulating end piece 1365 that surrounds an end portion of the contact housing 1352 near the second end 1362. A portion of the electrically insulating end piece 1365 is between the contact housing 1352 and the electrically conductive shield 1368. The electrically insulating end piece 1365 also defines a shoulder 1366 that extends radially outward.

The electrically conductive shield 1368 surrounds the piston 1351, most of the electrically insulating end piece 1365, and most of the contact housing 1352. The electrically conductive shield 1368 is in direct contact with an outer surface 1369 of the piston 1351. Thus, the electrically conductive shield 1368, the piston 1351, and the contact 1353 are electrically connected. Although the electrically conductive shield 1368 surrounds the contact housing 1352, the electrically conductive shield 1368 does not make direct contact with the contact housing 1352. Instead, the electrically conductive shield 1368 is radially separated from the contact housing 1352 by an open region 1372.

The electrical connector 1340 includes a spring 1360 that is in the open region 1372. The spring 1360 surrounds the contact housing 1352. One end of the spring 1360 is attached to the flange 1373 of the piston 1351, and the other end of the spring 1360 is attached to the annular shoulder 1366.

During ordinary, stead-state operation of the electrical connector 1340, the spring 1360 is in a relaxed or equilibrium state or in a slightly compressed state, and the contact assembly 1350 and the piston 1351 are in the original position. The spring 1360 does not exert a spring force on the piston 1351. During a load make operation, an external conductive probe enters the contact housing 1352 and moves in the −Z direction toward the connection points 1359. Arcing commences, generating gasses that move the piston 1351 and the contact assembly 1350 in the Z direction toward the open end 1345. The end piece 1365 does not move, and the spring 1360 compresses against the shoulder 1366. The compressed spring 1360 exerts a spring force on the piston 1351 in the −Z direction, propelling the piston 1351 and the contact assembly 350 (with the probe attached to the connection points 1359) in the −Z direction and back to the original position.

During a load break operation, the probe is removed from the connection points 1359. At the beginning of the load break operation, the probe is moved in the Z direction. Due to a hoop or radial force between the connection points 1359 and the probe, the connection points 1359 and the probe remain connected to the connection points 1359 as the piston 1351 and contact assembly 1350 move axially in the Z direction toward the open end 1345. Additionally, as the contact assembly 1350 and the piston 1351 move in the Z direction, the spring 1360 contracts and applies a force on the piston 1351 in the −Z direction. When the force applied by the spring 1360 exceeds the frictional force between the probe and the connection points 1359, the probe separates from the connection points 1359 and the force of the springs 1360 propels the piston 1351 and the contact assembly 1350 back to the original position while the probe exits the open end 1345.

These and other implementations are within the scope of the claims. For example, the electrical connector 240 may include elements not shown in FIGS. 2 to 7. Examples of such elements include a semiconductive shield on an exterior of the body 241.

What is claimed is:

1. A separable electrical connector comprising:
an electrically insulating body comprising an open end and an interior surface;
an electrically conductive shield on the interior surface;
an electrically conductive piston inside the electrically insulating body and in contact with the electrically conductive shield;
a contact assembly comprising:
an electrically conductive contact connected to the electrically conductive piston; and
an electrically insulating contact housing surrounding the electrically conductive contact; and
an elastic member surrounding the electrically insulating contact housing.

2. The separable electrical connector of claim 1, wherein the elastic member is configured to compress when the contact assembly and the electrically conductive piston move toward the open end.

3. The separable electrical connector of claim 2, further comprising an electrically insulating end piece comprising an opening that coincides with the open end of the electrically insulating body, and wherein the elastic member is configured to compress against the electrically insulating end piece when the contact assembly and the electrically conductive piston move toward the open end.

4. The separable electrical connector of claim 1, wherein the elastic member is in an open space between an outer surface of the electrically insulating contact housing and the electrically conductive shield.

5. The separable electrical connector of claim 1, further comprising a second elastic member that surrounds the electrically conductive piston.

6. The separable electrical connector of claim 5, wherein the second elastic member is configured to expand when the contact assembly and the electrically conductive piston move toward the open end.

7. The separable electrical connector of claim 6, wherein the electrically conductive piston comprises a piston body and an annular flange that extends radially outward from the piston body, the elastic member is on a first side of the annular flange, and the second elastic member is on a second side of the annular flange.

8. The separable electrical connector of claim 1, wherein the elastic member comprises a spring.

9. The separable electrical connector of claim 1, further comprising:
a semiconductive shield on an outer surface of the electrically body; and
a cable electrically connected to the electrically conductive shield.

10. An apparatus for a separable electrical connector, the apparatus comprising:
a contact assembly comprising:
an electrically conductive contact comprising a first end, a second end, and one or more deflectable electrical connection points at the second end, wherein the first end is configured for electrical and mechanical attachment to an electrically conductive piston; and
an electrically insulating contact housing surrounding the electrically conductive contact, the electrically insulating contact housing extending from a first end to a second end, the first end configured to make contact with the electrically conductive piston; and
an elastic member configured to apply force on the electrically conductive piston.

11. The apparatus of claim 10, wherein the elastic member surrounds the electrically insulating contact housing.

12. The apparatus of claim 10, wherein the elastic member comprises a spring.

13. The apparatus of claim 10, wherein the contact assembly further comprises one or more sealing members and an arc-quenching material.

14. The apparatus of claim 10, further comprising the electrically conductive piston.

15. A separable electrical connector comprising:
an insulating body comprising an open end and an electrically conductive member on an inner surface;
a contact assembly in the insulating body, the contact assembly comprising a contact housing that surrounds an electrical contact;
a piston electrically connected to the electrically conductive member; and
a spring assembly configured to apply a force on the piston.

16. The separable electrical connector of claim 15, wherein the contact assembly is configured to move between an original position and an outward position, and the spring assembly is substantially relaxed in the original position.

17. The separable electrical connector of claim 16, wherein the spring assembly is compressed when the contact assembly is in the outward position.

18. The separable electrical connector of claim 16, wherein the spring assembly is expanded when the contact assembly is in the outward position.

19. The separable electrical connector of claim 15, wherein the contact assembly is configured to move between an original position and an outward position, and wherein the spring assembly comprises a first spring and a second spring, the first spring surrounds the piston, the second spring surrounds the contact housing, the first spring is expanded when the contact assembly is in the outward position, and the second spring is compressed with the contact assembly is in the outward position.

20. A contact assembly for a separable electrical connector, the contact assembly comprising:
an electrically insulating contact housing surrounding an electrically conductive contact, the electrically insulating contact housing comprising: a sidewall that extends from a first end to a second end, the sidewall comprising an outer surface, and an inner surface, the inner surface defining an open interior, wherein the inner surface comprises a recess that faces the open interior; and
an electrically conductive contact in the open interior, the electrically conductive contact comprising a first end, a second end, and one or more deflectable electrical connection points at 10 the second end, wherein the first end is configured for electrical and mechanical attachment to an electrically conductive piston in the separable electrical connector.

21. The contact assembly of claim 20, wherein the recess comprises a channel that surrounds the open interior.
